(19) United States
(12) Patent Application Publication
(10) Pub. No.: US 2015/0065241 A1
(43) Pub. Date: Mar. 5, 2015

(54) GAMING SYSTEMS AND METHODS FOR FACILITATING ITEM GROUPING AND GROUP ACTIONS

(71) Applicant: Zynga Inc., San Francisco, CA (US)

(72) Inventor: Michael McCarthy, Oakland, CA (US)

(73) Assignee: Zynga Inc., San Francisco, CA (US)

(21) Appl. No.: 14/228,583

(22) Filed: Mar. 28, 2014

Related U.S. Application Data
(60) Provisional application No. 61/870,541, filed on Aug. 27, 2013.

(51) Int. Cl. G07F 17/32

(52) U.S. Cl. CPC G07F 17/3262; G07F 17/3272
USPC 463/31

(57) ABSTRACT

A system, computer-readable storage medium storing at least one program, and a computer-implemented method for providing game object grouping are discussed herein. For example, a virtual gaming environment is generated on a client system. The virtual gaming environment may include a first game object and a second game object. Responsive to detecting a user selection of the first game object, a game object grouping is generated. The game object grouping may include the first game object and the second game object based on matching criteria that compares a property of the first game object with a property of the second game object. The virtual environment is then updated to provide a visual indication of the game object group.

### CLAIM TO PRIORITY

This application claims the benefit of priority from U.S. Provisional Patent Application, Ser. No. 61/870,541, entitled “GAMING SYSTEMS AND METHODS FOR FACILITATING ITEM GROUPING AND GROUP ACTIONS,” and filed Aug. 27, 2013, all of which is incorporated herein by reference in its entirety for all purposes.

### TECHNICAL FIELD

The subject matter disclosed herein generally relates to the processing of data. Specifically, the present disclosure addresses systems and methods to facilitate user interactions with a computer-implemented game.

### BACKGROUND

Many traditional online games may offer user interface mechanics for performing game actions on selected game objects. For example, in a virtual farming game, a player may harvest a crop by selecting the individual crop and then selecting the type of game action that is to be performed on the selected individual crop. To harvest a second crop, the user may select the second crop and then select the appropriate game action for the second crop. This selection of a crop and then game action is repeated for each crop the user wishes to harvest.

### BRIEF DESCRIPTION OF THE DRAWINGS

The present disclosure is illustrated by way of example, and not limitation, in the figures of the accompanying drawings, in which like reference numerals indicate similar elements unless otherwise indicated.

FIG. 1 illustrates an example of a system for implementing various disclosed embodiments.

FIG. 2 illustrates an example social network, according to an example embodiment.

FIG. 3 is a block diagram illustrating example modules of a grouping game system, according to an example embodiment.

FIG. 4 is a user interface diagram illustrating game interface for a game executed by the grouping game system of FIG. 3, according to an example embodiment.

FIG. 5 is a user interface diagram illustrating a user's interaction with the game interface shown in FIG. 3, according to an example embodiment.

FIG. 6 is a user interface diagram illustrating a game object grouping formed on the user's interaction with the game interface shown in FIG. 5, according to an example embodiment.

FIG. 7 is a user interface diagram illustrating a group game action performed on a game object grouping, according to an example embodiment.

FIG. 8 is a flowchart of a method for generating a game object group, according to an example embodiment.

FIG. 9 is a flowchart of a method for generating executing a group game action on a game object group, according to an example embodiment.

FIG. 10 is a user interface diagram illustrating an example game action selection menu, according to an example embodiment.

FIG. 11 illustrates an example data flow in a system, according to an example embodiment.

FIG. 12 illustrates an example network environment, according to an example embodiment.

FIG. 13 illustrates an example computing system architecture, according to an example embodiment.

### DESCRIPTION OF EXAMPLE EMBODIMENTS

### Brief Overview

Example systems and methods of providing an object grouping user interface is provided. In the following description, for purposes of explanation, numerous specific details are set forth in order to provide a thorough understanding of example embodiments. It will be evident, however, to one skilled in the art that the described systems and methods may be practiced without these specific details.

The systems and methods described herein allow a user to initiate object grouping and group actions. For example, in the context of a video game, a game operating on a client device (e.g., a phone, tablet, laptop, or any other suitable computer system) may provide a game display. The game display may provide the user with the ability to select individual game objects. Upon detecting a player selection corresponding to a game object, an example embodiment of the game may group an additional game object (or game objects) with the selected game object based on the additional game object satisfying matching criteria. The group of game objects formed from the selected game object and the additional game objects that match or otherwise satisfy the matching criteria may be referred to as a game object grouping.

An example embodiment of the game may then provide a game action interface to the player to allow the player to select a type of game action to be performed on the game object grouping. Upon detecting a selection of a type of game action, an embodiment of the game may then perform a game action of the selected game action type on both the selected game object and the additional game object. That is, the game action interface may allow a player to initiate a type of game action on the game object grouping.

The matching criteria, according to some embodiments, may use location information from the selected game object and the additional game objects. For example, according to an example embodiment, the matching criteria may be game objects that are adjacent to the selected game object. As another example, the matching criteria may be game objects that are within a distance threshold of the selected game object. Additionally or alternatively, some embodiments may use available game actions as matching criteria. For example, in addition to location information, the additional game object may be selected based on the additional game object permitting a same type of game action as the selected game object.

Example embodiments may provide many useful, practical applications. For example, a game configured to perform object grouping and grouping actions may provide comparatively convenient user interactions with a game. Such may be the case in games played using a touch screen. To illustrate, games played through a touch screen device may allow a player to select a game object by “tapping” the game object. However, in a lot of cases, the physical act of tapping a game object may be difficult (because, e.g., requiring a user to “touch” small game objects may be difficult for many players) and may be repetitive (e.g., where the player is trying to harvest a field that includes many crops). Thus, the object grouping performed by some example embodiments may limit the number of times a player needs to repeatedly perform a possibly difficult act of selecting many game objects.

Further, example embodiments may provide the technical improvement of reducing power consumption in that some embodiments may limit the frequency in which processing times of a touch screen are utilized. Such may be important for mobile devices, which may rely on batteries as a power source.

These and other embodiments are described in greater below.

### Example System

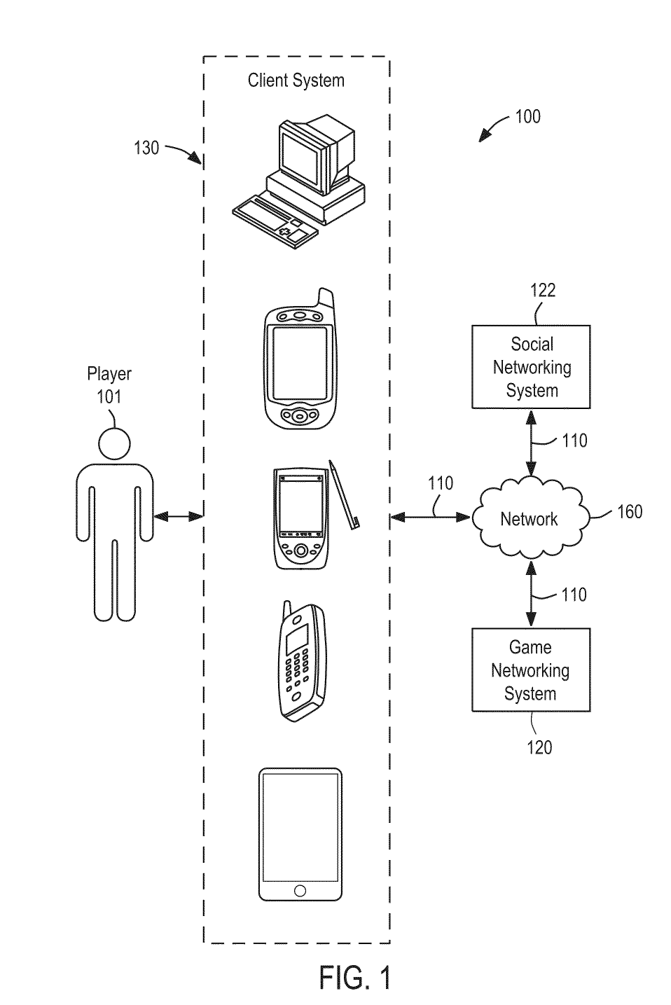

FIG. 1 illustrates an example of a system for implementing various disclosed embodiments. In particular embodiments, system 100 comprises player 101, social networking system 122, game networking system 120, client system 130, and network 160. The components of system 100 can be connected to each other in any suitable configuration, using any suitable type of connection. The components may be connected directly or over a network 160, which may be any suitable network. For example, one or more portions of network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

Social networking system 122 is a network-addressable computing system that can host one or more social graphs. Social networking system 122 can generate, store, receive, and transmit social networking data. Social networking system 122 can be accessed by the other components of system 100 either directly or via network 160. Game networking system 120 is a network-addressable computing system that can host one or more online games. Game networking system 120 can generate, store, receive, and transmit game-related data, such as, for example, game account data, game input, game state data, and game displays. Game networking system 120 can be accessed by the other components of system 100 either directly or via network 160. Player 101 may use client system 130 to access, send data to, and receive data from social networking system 122 and game networking system 120. Client system 130 can access social networking system 122 or game networking system 120 directly, via network 160, or via a third-party system. As an example and not by way of limitation, client system 130 may access game networking system 120 via social networking system 122. Client system 130 can be any suitable computing device, such as a personal computer, laptop, cellular phone, smart phone, computing tablet, and the like.

Although FIG. 1 illustrates a particular number of players 101, social networking systems 122, game networking systems 120, client systems 130, and networks 160, this disclosure contemplates any suitable number of players 101, social networking systems 122, game networking systems 120, client systems 130, and networks 160. As an example and not by way of limitation, system 100 may include one or more game networking systems 120 and no social networking systems 122. As another example and not by way of limitation, system 100 may include a system that comprises both social networking system 122 and game networking system 120. Moreover, although FIG. 1 illustrates a particular arrangement of player 101, social networking system 122, game networking system 120, client system 130, and network 160, this disclosure contemplates any suitable arrangement of player 101, social networking system 122, game networking system 120, client system 130, and network 160.

The components of system 100 may be connected to each other using any suitable connections 110. For example, suitable connections 110 include wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, one or more connections 110 each include an ad hoc network, an intranet, an extranet, a VPN, a LAN, a WLAN, a WAN, a WWAN, a MAN, a portion of the Internet, a portion of the PSTN, a cellular telephone network, or another type of connection, or a combination of two or more such connections. Connections 110 need not necessarily be the same throughout system 100. One or more first connections 110 may differ in one or more respects from one or more second connections 110. Although FIG. 1 illustrates particular connections between player 101, social networking system 122, game networking system 120, client system 130, and network 160, this disclosure contemplates any suitable connections between player 101, social networking system 122, game networking system 120, client system 130, and network 160. As an example and not by way of limitation, in particular embodiments, client system 130 may have a direct connection to social networking system 122 or game networking system 120, bypassing network 160.

### Online Games and Game Systems

In an online computer game, a game engine manages the game state of the game. Game state comprises all game play parameters, including player character state, non-player character (NPC) state, in-game object state, game world state (e.g., internal game clocks, game environment), and other game play parameters. Each player 101 controls one or more player characters (PCs). The game engine controls all other aspects of the game, including non-player characters (NPCs), and in-game objects. The game engine also manages game state, including player character state for currently active (online) and inactive (offline) players.

An online game can be hosted by game networking system 120, which can be accessed using any suitable connection with a suitable client system 130. A player 101 may have a game account on game networking system 120, wherein the game account can contain a variety of information associated with the player 101 (e.g., the player's personal information, financial information, purchase history, player character state, game state). In some embodiments, the player 101 may play multiple games on game networking system 120, which may maintain a single game account for the player 101 with respect to all the games, or multiple individual game accounts for each game with respect to the player 101. In some embodiments, game networking system 120 can assign a unique identifier to each player 101 of an online game hosted on game networking system 120. Game networking system 120 can determine that a player 101 is accessing the online game by reading the user's cookies, which may be appended to HTTP requests transmitted by client system 130, and/or by the player 101 logging onto the online game.

In particular embodiments, player 101 may access an online game and control the game's progress via client system 130 (e.g., by inputting commands to the game at the client device). Client system 130 can display the game interface, receive inputs from player 101, transmit user inputs or other events to the game engine, and receive instructions from the game engine. The game engine can be executed on any suitable system (such as, for example, client system 130, social networking system 122, or game networking system 120). As an example and not by way of limitation, client system 130 can download client components of an online game, which are executed locally, while a remote game server, such as game networking system 120, provides backend support for the client components and may be responsible for maintaining application data of the game, processing the inputs from the player 101, updating and/or synchronizing the game state based on the game logic and each input from the player 101, and transmitting instructions to client system 130. As another example and not by way of limitation, each time player 101 provides an input to the game through the client system 130 (such as, for example, by typing on the keyboard or clicking the mouse of client system 130), the client components of the game may transmit the player's input to game networking system 120.

In an online multiplayer game, players may control player characters (PCs), a game engine controls non-player characters (NPCs) and game features, and the game engine also manages player character state and game state and tracks the state for currently active (i.e., online) players and currently inactive (i.e., offline) players. A player character can have a set of attributes and a set of friends associated with the player character. As used herein, the term “player character state” can refer to any in-game characteristic of a player character, such as location, assets, levels, condition, health, status, inventory, skill set, name, orientation, affiliation, specialty, and so on. Player characters may be displayed as graphical avatars within a user interface of the game. In other implementations, no avatar or other graphical representation of the player character is displayed. Game state encompasses the notion of player character state and refers to any parameter value that characterizes the state of an in-game element, such as a non-player character, a virtual object (such as a wall or castle), and so forth. The game engine may use player character state to determine the outcome of game events, sometimes also considering set or random variables. Generally, a player character's probability of having a more favorable outcome is greater when the player character has a better state. For example, a healthier player character is less likely to die in a particular encounter relative to a weaker player character or non-player character. In some embodiments, the game engine can assign a unique client identifier to each player 101.

In particular embodiments, player 101 may access particular game instances of an online game. A game instance is a copy of a specific game play area that is created during runtime. In particular embodiments, a game instance is a discrete game play area where one or more players 101 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players) or non-exclusive (i.e., accessible by any player). In particular embodiments, a game instance is populated by one or more player characters controlled by one or more players 101 and one or more in-game objects controlled by the game engine. When accessing an online game, the game engine may allow player 101 to select a particular game instance to play from a plurality of game instances. Alternatively, the game engine may automatically select the game instance that player 101 will access. In particular embodiments, an online game comprises only one game instance that all players 101 of the online game can access.

In particular embodiments, a specific game instance may be associated with one or more specific players 101. A game instance is associated with a specific player 101 when one or more game parameters of the game instance are associated with the specific player 101. As an example and not by way of limitation, a game instance associated with a first player 101 may be named “First Player's Play Area.” This game instance may be populated with the first player's PC and one or more in-game objects associated with the first player 101. In particular embodiments, a game instance associated with a specific player 101 may only be accessible by that specific player 101. As an example and not by way of limitation, a first player 101 may access a first game instance when playing an online game, and this first game instance may be inaccessible to all other players 101. In other embodiments, a game instance associated with a specific player 101 may be accessible by one or more other players, either synchronously or asynchronously with the specific player's game play. As an example and not by way of limitation, a first player 101 may be associated with a first game instance, but the first game instance may be accessed by all first-degree friends in the first player's social network. In particular embodiments, the game engine may create a specific game instance for a specific player 101 when that player 101 accesses the game. As an example and not by way of limitation, the game engine may create a first game instance when a first player 101 initially accesses an online game, and that same game instance may be loaded each time the first player 101 accesses the game. As another example and not by way of limitation, the game engine may create a new game instance each time a first player 101 accesses an online game, wherein each game instance may be created randomly or selected from a set of predetermined game instances. In particular embodiments, the set of in-game actions available to a specific player 101 may be different in a game instance that is associated with that player 101 compared to a game instance that is not associated with that player 101. The set of in-game actions available to a specific player in a game instance associated with that player 101 may be a subset, superset, or independent of the set of in-game actions available to that player 101 in a game instance that is not associated with him. As an example and not by way of limitation, a first player 101 may be associated with Blackacre Farm in an online farming game. The first player 101 may be able to plant crops on Blackacre Farm. If the first player 101 accesses a game instance associated with another player 101, such as Whiteacre Farm, the game engine may not allow the first player 101 to plant crops in that game instance. However, other in-game actions may be available to the first player 101, such as watering or fertilizing crops on Whiteacre Farm.

In particular embodiments, a game engine can interface with a social graph. Social graphs are models of connections between entities (e.g., individuals, users, contacts, friends, players, player characters, non-player characters, businesses, groups, associations, concepts, and the like). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph. This disclosure assumes that at least one entity of a social graph is a player or player character in an online multiplayer game, though this disclosure includes any suitable social graph users.

The minimum number of edges required to connect a player (or player character) to another user is considered the degree of separation between them. For example, where the player and the user are directly connected (one edge), they are deemed to be separated by one degree of separation. The user would be a so-called “first-degree friend” of the player. Where the player and the user are connected through one other user (two edges), they are deemed to be separated by two degrees of separation. This user would be a so-called “second-degree friend” of the player. Where the player and the user are connected through N edges (or N-1 other users), they are deemed to be separated by N degrees of separation. This user would be a so-called “Nth-degree friend.” As used herein, the term “friend” means only first-degree friends, unless context suggests otherwise.

Within the social graph, each player (or player character) has a social network. A player's social network includes all users in the social graph within Nₘₐₓ degrees of the player, where Nₘₐₓ is the maximum degree of separation allowed by the system managing the social graph (such as, for example, social networking system 122 or game networking system 120). In one embodiment, Nₘₐₓ equals 1, such that the player's social network includes only first-degree friends. In another embodiment, N. is unlimited and the player's social network is coextensive with the social graph.

In particular embodiments, the social graph is managed by game networking system 120, which is managed by the game operator. In other embodiments, the social graph is part of a social networking system 122 managed by a third-party (e.g., Facebook®, Friendster, Myspace). In yet other embodiments, player 101 has a social network on both game networking system 120 and social networking system 122, wherein player 101 can have a social network on the game networking system 120 that is a subset, superset, or independent of the player's social network on social networking system 122. In such combined systems, game network system 120 can maintain social graph information with edge type attributes that indicate whether a given friend is an “in-game friend,” an “out-of-game friend,” or both. The various embodiments disclosed herein are operable when the social graph is managed by social networking system 122, game networking system 120, or both.

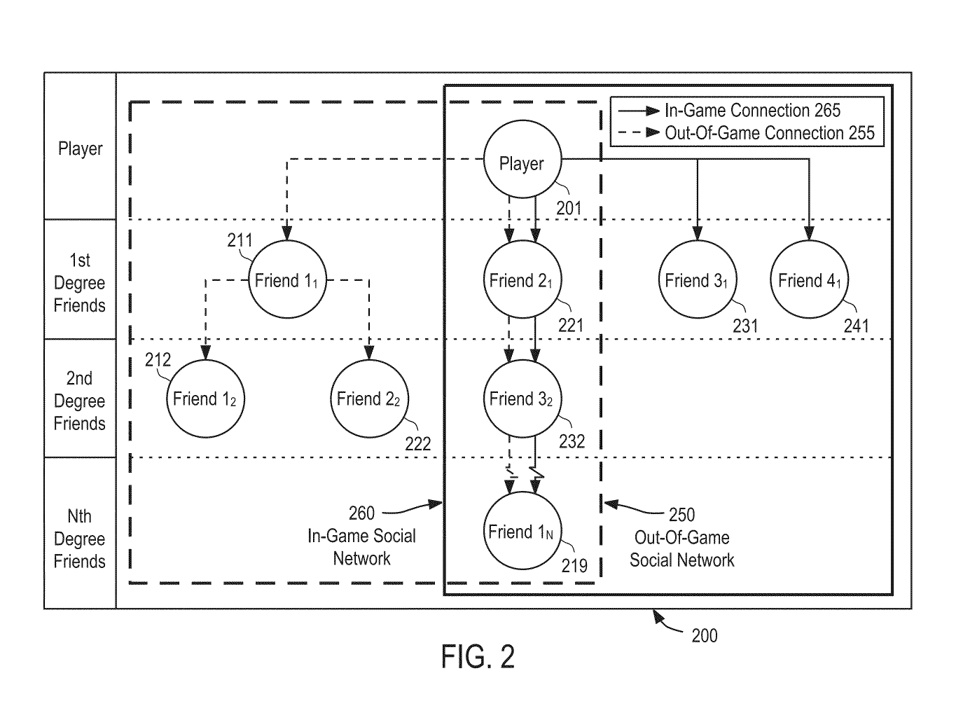

FIG. 2 shows an example of a social network within a social graph, according to an example embodiment. As shown, Player 201 can be associated, connected or linked to various other users, or “friends,” within the social network 250. These associations, connections or links can track relationships between users within the social network 250 and are commonly referred to as online “friends” or “friendships” between users. Each friend or friendship in a particular user's social network within a social graph is commonly referred to as a “node.” For purposes of illustration and not by way of limitation, the details of social network 250 will be described in relation to Player 201. As used herein, the terms “player” and “user” can be used interchangeably and can refer to any user or character in an online multiuser game system or social networking system. As used herein, the term “friend” can mean any node within a player's social network.

As shown in FIG. 2, Player 201 has direct connections with several friends. When Player 201 has a direct connection with another individual, that connection is referred to as a first-degree friend. In social network 250, Player 201 has two first-degree friends. That is, Player 201 is directly connected to Friend 1₁ 211 and Friend 2₁ 221. In a social graph, it is possible for individuals to be connected to other individuals through their first-degree friends (i.e., friends of friends). As described above, each edge required to connect a player to another user is considered the degree of separation. For example, FIG. 2 shows that Player 201 has three second-degree friends to which he is connected via his connection to his first-degree friends. Second-degree Friend 1₂ 212 and Friend 2₂ 222 are connected to Player 201 via his first-degree Friend 1₁ 211. The limit on the depth of friend connections, or the number of degrees of separation for associations, that Player 201 is allowed is typically dictated by the restrictions and policies implemented by social networking system 122.

In various embodiments, Player 201 can have Nth-degree friends connected to him through a chain of intermediary degree friends as indicated in FIG. 2. For example, Nth-degree Friend 1_{N} 219 is connected to Player 201 via second-degree Friend 3₂ 232 and one or more other higher-degree friends. Various embodiments may take advantage of and utilize the distinction between the various degrees of friendship relative to Player 201.

In particular embodiments, a player (or player character) can have a social graph within an online multiplayer game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in his out-of-game social network 250. Player 201 also has in-game connections 265 to a plurality of players, forming in-game social network 260. Here, Friend 2₁ 221, Friend 3₁ 231, and Friend 4₁ 241 are first-degree friends with Player 201 in his in-game social network 260. In some embodiments, it is possible for a friend to be in both the out-of-game social network 250 and the in-game social network 260. Here, Friend 2₁ 221 has both an out-of-game connection 255 and an in-game connection 265 with Player 201, such that Friend 2₁ 221 is in both Player 201's in-game social network 260 and Player 201's out-of-game social network 250.

As with other social networks, Player 201 can have second-degree and higher-degree friends in both his in-game and out of game social networks. In some embodiments, it is possible for Player 201 to have a friend connected to him both in his in-game and out-of-game social networks, wherein the friend is at different degrees of separation in each network. For example, if Friend 2₂ 222 had a direct in-game connection with Player 201, Friend 2₂ 222 would be a second-degree friend in Player 201's out-of-game social network, but a first-degree friend in Player 201's in-game social network. In particular embodiments, a game engine can access in-game social network 260, out-of-game social network 250, or both.

In particular embodiments, the connections in a player's in-game social network can be formed both explicitly (e.g., users must “friend” each other) and implicitly (e.g., system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (i.e., in disintermediated interactions or the like), but that could be the case.

### Example Modules of a Grouping Game Engine

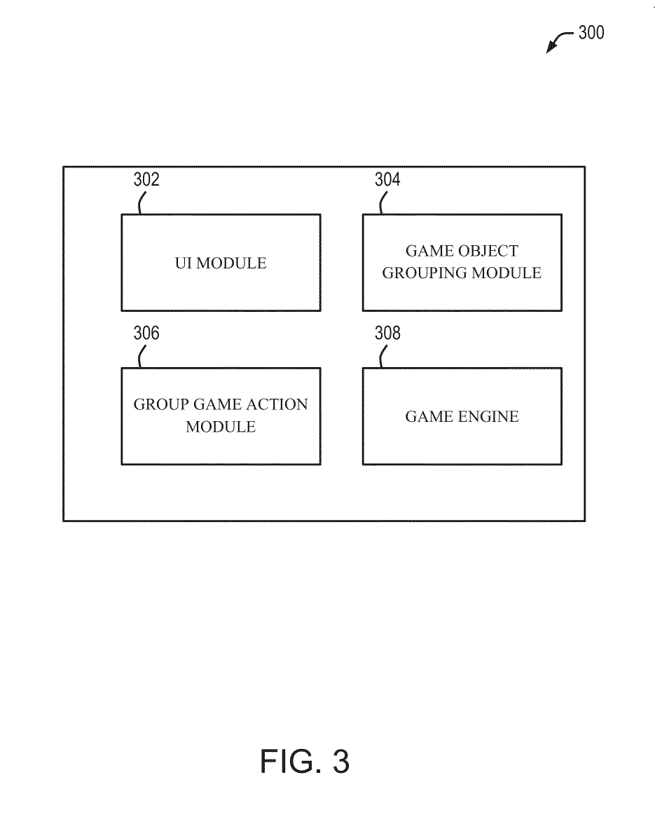

FIG. 3 is a block diagram illustrating example modules of a grouping game system 300, according to an example embodiment. As described herein, the grouping game system 300 facilitates user initiated game interactions for game object grouping and group game actions. The grouping game system 300 includes a user interface module 302, a game object grouping module 304, a group game action module 306, and a game engine 308.

The user interface module 302 may be a computer implemented system configured to receive user input and to output game data to a user. For example, the user interface module 302 may generate or otherwise render display data for a game running on the client system 130. Display data may refer to data or logic that can be used to generate the visual display of a game. In some embodiments, display data may specify one or more game objects to be displayed, the location or coordinates of those game objects, and any visual effects associated with those game objects. As another example, the user interface module 302 may receive user input from the player playing the game. User input may include data specifying a type of input trigger (e.g. mouse-click, button pressed, mouse drag, touch screen interaction, and the like). The user input may be communicated by the user interface module 302 to the game engine 308 to cause the game engine 308 to update the state of the game.

The game object grouping module 304 may be a computer implemented system configured to form game object groupings. For example, the game object grouping module 304 may form a game object grouping based on a user selection of one game object and, using a matching criteria, matching the selected game object with other game objects in the game. The selected game object with the matching game objects may form a game object grouping.

The group game action module 306 may be a computer implemented module configured to perform a game action on a game object group, as may be formed by the game object grouping module 304.

The game engine 308 may be a computer implemented module configured to process game logic and game data that express the game rules and logic of a game. For example, the game engine 308 may be configured to execute or simulate a game action on a game object, which may in turn involve updating the state of the game object or any other affected part of the game.

In some embodiment, the modules of the grouping game system 300 may be deployed as part of the game networking system 120 of FIG. 1, the client system 130 of FIG. 1, or some combination thereof. For example, the user interface module 302, the game object grouping module 304, the group game action module 306, and the game engine 308 may each reside on the client system 130. Or, as another example, the user interface module 302, the game object grouping module 304, the group game action module 306, and the game engine 308 may each reside on the game networking system 120. Still further, one or more of the user interface module 302, the game object grouping module 304, the group game action module 306, and the game engine 308 may reside on the client system 130, while those modules not residing on the client system 130, may reside on the game networking system 120.

### Example User Interfaces for Game Object Grouping and Group Game Actions

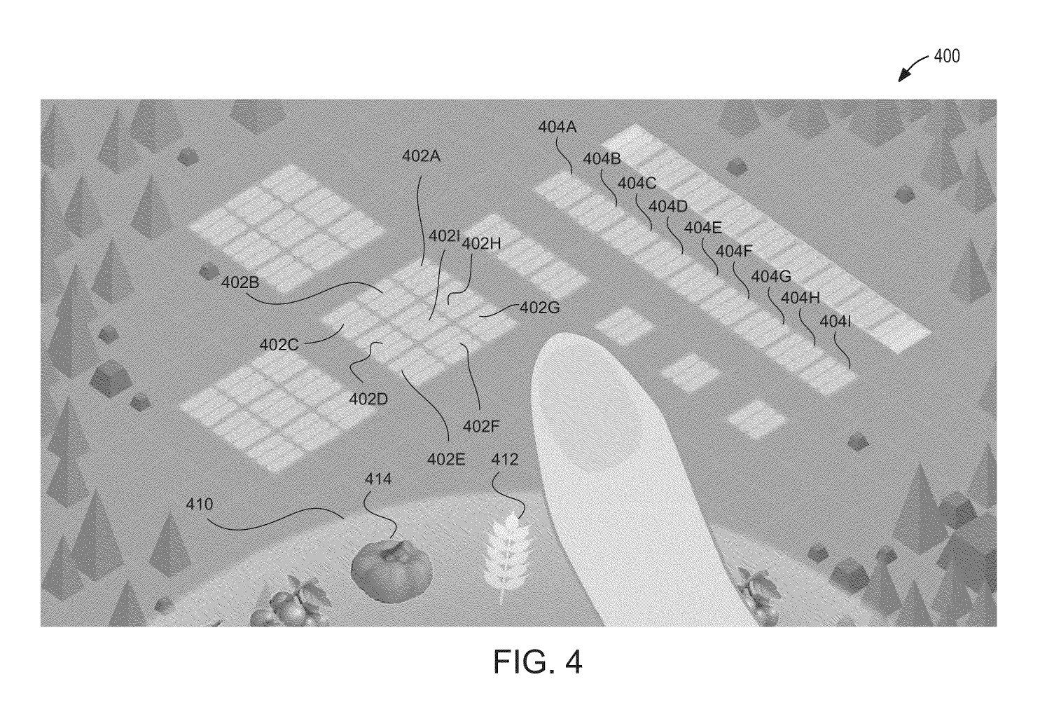

FIG. 4 is a user interface diagram illustrating game interface 400 for a game executed by the grouping game system 300 of FIG. 3, according to an example embodiment. As shown, the game interface 400 may display various game objects 402A-I in a virtual game environment. The various game objects may be interactive elements in a game that each includes corresponding state data, which may, for example, characterize the corresponding game object's location, available game actions, a time until the next state change, current level, a status, and the like. As FIG. 4 shows, none of the game objects are currently selected. For clarity of description, each of the game objects 402A-I may represent a plot of land that have at least the following game actions available: move (e.g., the user may move the location within the gaming environment to which the game object is assigned to another location), plant (e.g., the user may plant the game object with a seed of a particular type of crop), remove (e.g., the user may remove the game object from the virtual gaming environment), and the like. The game objects 402A-I, in some embodiments, may be rendered by the user interface module 302 using game data received from the game engine module 308.

In addition to the game objects 402A-I, the game interface may also display game objects 404A-I. The game objects 404A-I may be similar to the game objects 402A-I in that each of the individual game objects include state data that characterize properties of the game object.

In some cases, a game object may be connected to another game object. As used herein, a game object may be directly connected to another game object when the two game objects are adjacent to each other, such as located at cells within the virtual environment that are adjacent to each other (e.g., horizontally, vertically, or, in some cases, diagonally). A first game object may be indirectly connected to a second game object where a path exists from the first game object to the second game object, where the edges of the path are formed by connected game objects that are directly connected. The term connected may generally refer to both direct connections and indirect connections. To illustrate, the individual game objects 404A-I may be directly or indirectly connected with each other. For example, game object 404A may be connected to game object 404B based on these game objects sharing a common edge or being located at adjacent cells within the virtual game environment. Further, the game object 404B may be connected to game object 404D as the game object 404B is directly connected to game object 404C which, in turn, is directly connected to game object 404D. Likewise, the game objects 402A-I may be connected, directly or indirectly, to each other. However, none of the game objects 404A-I are connected to any of the game objects 402A-I because none of the individual game objects of game objects 404A-I are adjacent to a game object from 402A-I.

The game interface may also include a game action selection menu 410, which may be a menu with selectable game action choices 412 and 414. Each of the selectable game action choices may represent a type of game action in which the grouping game system 300 may perform relative to a selected game object or a game object group.

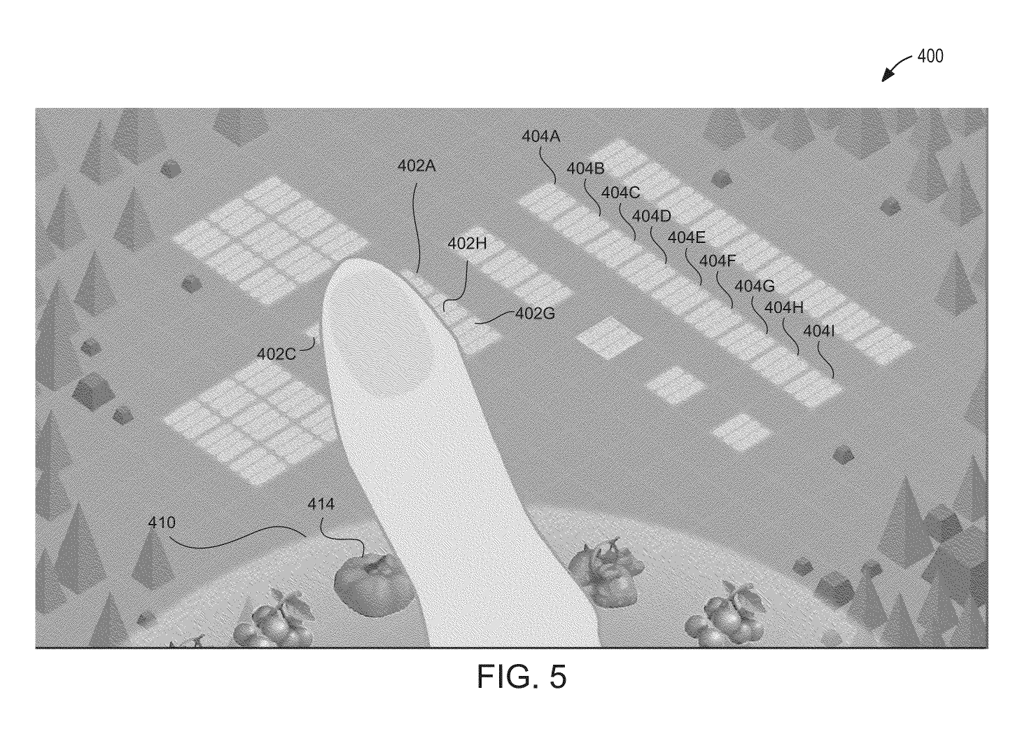

FIG. 5 is a user interface diagram illustrating a user's interaction with the game interface 400 shown in FIG. 3, according to an example embodiment. As shown in FIG. 5, the player may select one of the game objects 402A-I by tapping or selecting a location associating with the selected game object 402A. For clarity of description, FIG. 5 assumes that the game object 4021 was selected. Upon detecting that the game object 402I was selected, the game object grouping module 304 may form a game object group based on a comparison, using a matching criteria, between the game object 402I and other game objects. The method of forming game object groups is discussed in greater detail below.

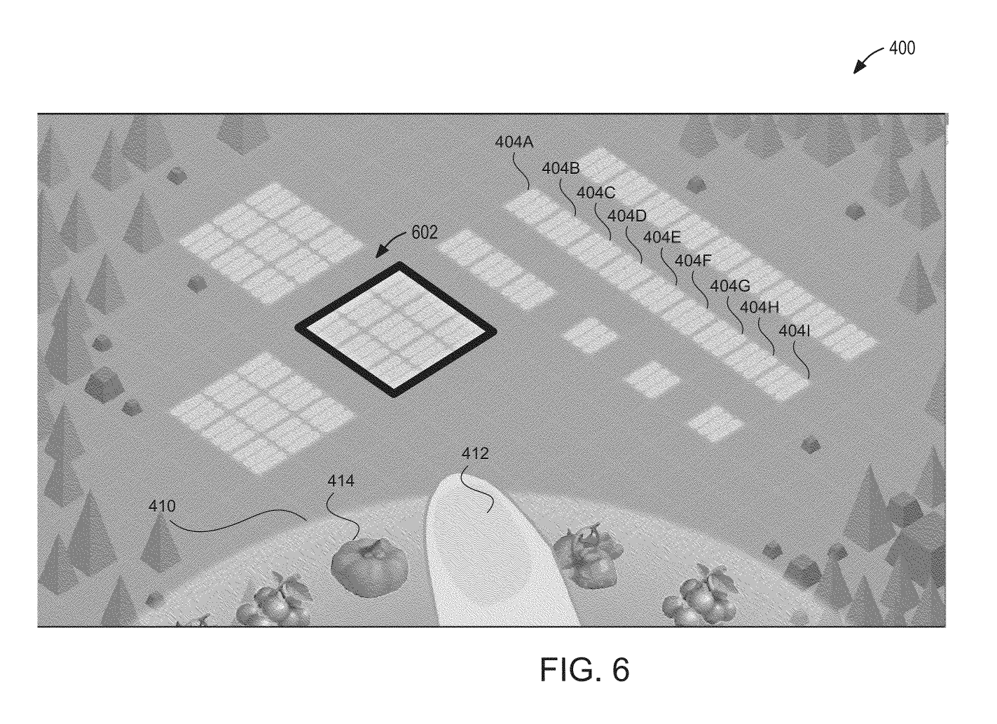

FIG. 6 is a user interface diagram illustrating a game object grouping formed on the user's interaction with the game interface 400 shown in FIG. 5, according to an example embodiment. In particular, based on the selection of game object 402I, the grouping game system 300 may form the game object grouping 602 that is comprised of the game objects 402A-I. In some cases, the game engine 308 may cause the game object grouping 602 to be highlighted or otherwise distinguished within the virtual gaming environment. It should be appreciated that game objects 404A-I were not selected by the grouping game system 300 to be a part of the game object grouping 602. Such may be the case because the matching criteria used by the grouping game system 300 may select game objects that are connected or otherwise adjacent to the selected game object (e.g., game object 4021).

Thus, at least according to FIGS. 4-6, the grouping game system 300 may be used to select multiple game objects based on a user initiating the selection of a single game object.

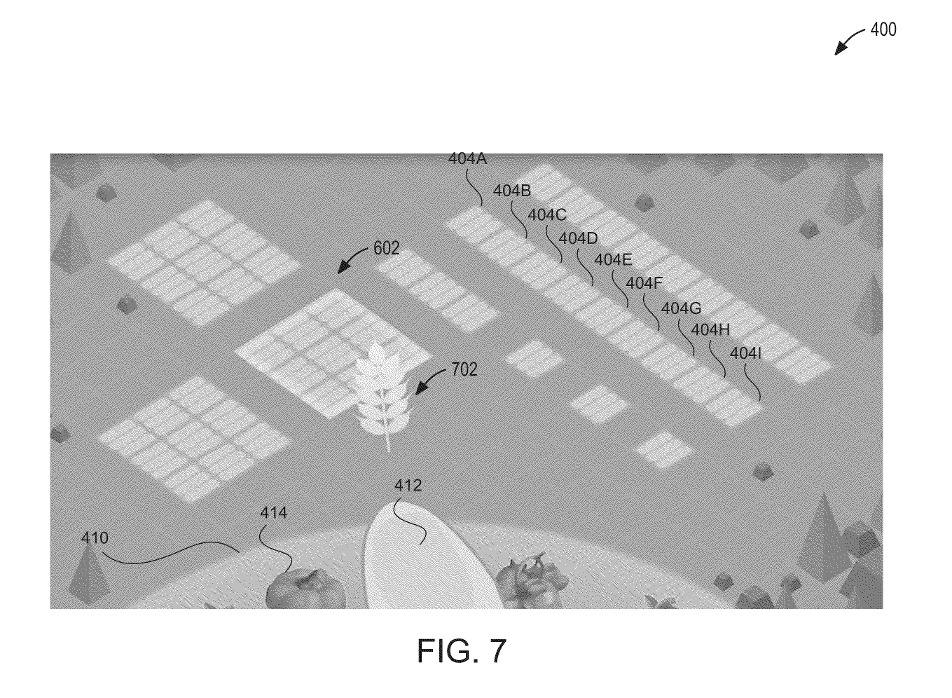

FIG. 7 is a user interface diagram illustrating a group game action 702 performed on a game object grouping, according to an example embodiment. In particular, the player has initiated a game action 702 by selecting the selectable game action choice 412 and the grouping game system 300 may perform the initiated game action 702 on each of the game objects (e.g., game objects 402A-I) of the game object grouping 602. As discussed in greater detail below, the game action selected may be based on a default game action or a game action selected by the player.

### Example Methods for Game Object Grouping and Group Game Actions

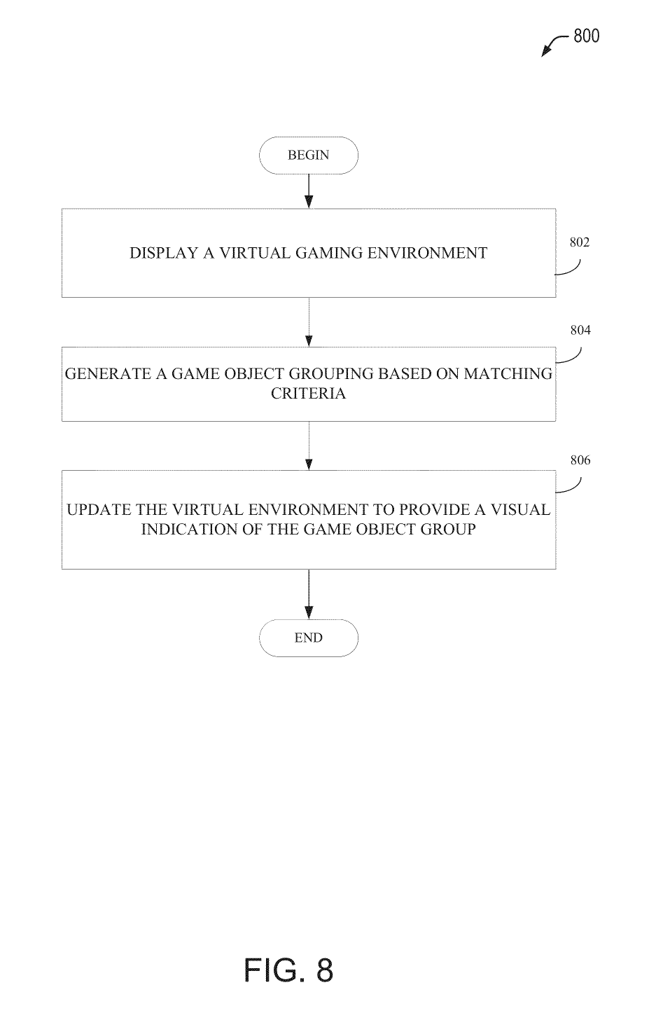

FIG. 8 is a flowchart of a method 800 for generating a game object group, according to an example embodiment. In some embodiments, the method 800 is implemented by one or more processors, as may be executed by one or more modules shown in FIG. 3, and, accordingly, is described herein merely by way of reference thereto. However, it will be appreciated that the method 800 may be performed on any suitable hardware.

The method 800 begins, at operation 802, when the user interface module 302 causes the client system 130 to display a virtual gaming environment for a game. In some cases, the user interface module 302 may generate display data that characterizes a virtual environment that includes multiple game objects, such as the virtual environment shown in the user interface 400 shown in FIGS. 4-7.

Responsive to detecting a user selection of one of the multiple game objects (e.g., a first game object), at operation 804, the game object grouping module 304 may generate a game object grouping that includes the first game object and a second game object. In some embodiments, the game object grouping is based on matching criteria that compares the first game object with another game object. Based on the comparison, the other game objects may be included in the game object group. By way of example and not limitation, matching criteria may include adding a game object to the game object group if the game object is connected or otherwise adjacent to the selected game object. Other example matching criteria may include a game object based on other criteria, such as whether: the same type of game action may be executed on each of game objects; the game objects have the same state; the game objects are owned by the same player; some combination of the above; or the like.

At operation 806, the game object grouping module 304 may cause the user interface module 302 to update the virtual environment to provide a visual indication of the game object group. Such a visual indication is shown respective to the game object grouping 602 shown in FIG. 6.

One skilled in the art may appreciate that the method 800 may provide, in some cases, a comparatively efficient method for selecting multiple game objects. Such is the case because the player simply selects a first game object and then the game object grouping module 304 then selects one or more additional game objects on behalf the player. This “automatic” selection of game objects may, in some cases, reduce the number of selections a player makes through traditional “tapping” or “clicking.” Further, a reduction in processing such “taps” and “clicks” may reduce the resource consumption of a computer system, as the computer system does not have to process handlers or routines that typically process such events or interrupts.

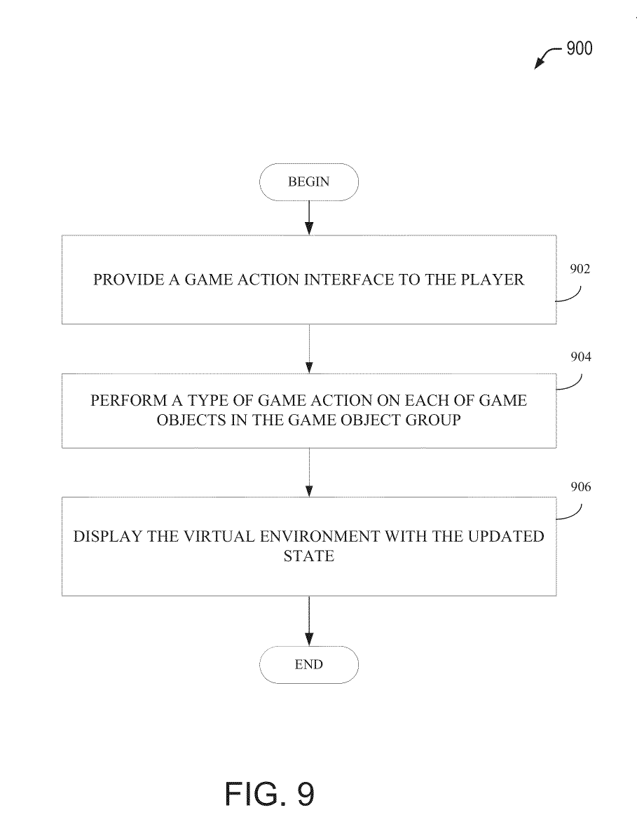

FIG. 9 is a flowchart of a method 900 for generating executing a group game action on a game object group, according to an example embodiment. In some embodiments, the method 900 is implemented by one or more processors, as may be executed by one or more modules shown in FIG. 3, and, accordingly, is described herein merely by way of reference thereto. However, it will be appreciated that the method 800 may be performed on any suitable hardware. In some cases, the method may be performed subsequent to performing the method 800 of FIG. 8.

The method 900 begins, at operation 902, when the group game action module 306 provides a game action interface to the player. A game action interface may be data or logic that is displayable to a player in a manner that lists the available game actions available to be performed individually on the game objects of the game object groups. For example, and as discussed in greater detail below, the game action module 306 may cause the user interface module 302 to display a game action selection menu, such as the game action selection menu 410 shown in FIG. 4.

At operation 904, responsive to detecting a selection of a type of game action that is to be performed, the game action module 306 may then perform the selected type of game action on each of game objects in the game object group. For example, where the game object is a plot of land with a harvestable crop, and the game action type is harvest, then the game action module 304 may cause the game engine 308 to execute the harvest game action on each of the plots of land. Performing the game action may cause the game engine 308 to update state data relating to the game objects (e.g., advance the state of the plot of land to be empty), as well as the player (e.g., increment the inventory associated the player to include the harvested crops) and the virtual environment.

It is to be appreciated that operation 902 may be optional. Where the method 900 does not perform operation 902, the game action module 306 may detect by making a selection of a game action on behalf of the player. For example, in some embodiments, detecting the type of game action may be inferred by a default type of game action associated with one or more game objects in the game object group. Using the farming game as an example, where the state of the plots indicate that the crops are ready for harvest, tapping any one of the game objects in the game object group may infer that the type of game action that is to be performed is the harvest game action.

At operation 906, the user interface module 302 may cause the client system 130 to display the virtual environment with the updated state generated based on performing the game actions on each game object in the game object grouping.

One skilled in the art may appreciate that the method 900 may provide, in some cases, a comparatively efficient method for performing game actions on multiple game objects. Such is the case because the player simply makes a selection of one type of game action and that type of game action is then applied to each of the game objects in the game object group. This “automatic” execution of the type of game action may, in some cases, reduce the number of selections a player makes through traditional “tapping” or “clicking” methods. Further, a reduction in processing such “taps” and “clicks” may reduce the resource consumption of a computer system, as the computer system does not have to process handlers or routines that typically process such events or interrupts.

### Example Game Action Selection Menu

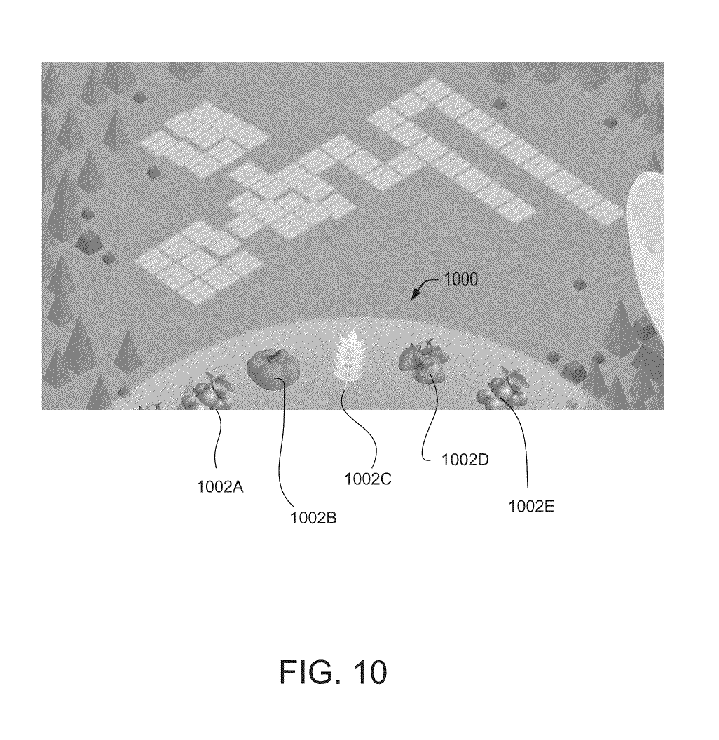

FIG. 10 is a user interface diagram illustrating an example game action selection menu 1000, according to an example embodiment. In some embodiments, the user interface module 302 may cause the client system 130 to display the game action selection menu 1000 responsive to the game object grouping module 304 forming a game object group (e.g., when a player taps a game object). As shown in FIG. 10, the game action selection menu 1000 may display one or more selectable game action choices 1002A-E that may be selected by the user. The selectable game action choices 1002A-E may each specify a different state change for a game object group. For example, the selectable game action choice 1002B may result in changing an empty plot to a plot that his growing tomatoes, and the selectable game action choice 1002C may result in changing an empty plot to a plot that his growing wheat.

In some embodiments, the game action selection menu 1000 may present the selectable game action choices in a wheel selector. A wheel selector may allow the user to move the different game action types by dragging the wheel in a particular direction (e.g., left or right). When the wheel moves, for example, to the left, a selectable game action choice on one edge of the displayable portion of the wheel (e.g. 1002A) may move off the displayable portion of the game environment, the locations of the remaining selectable game action choices may be updated to so that they are shifted in the user selected direction, and a new selectable game action choice may be moved to the opposite end of the game selection menu 1000.

Although FIG. 10 shows a single game action selection menu 1000, other embodiments may organize multiple game action selection menus in a tab structure. In a tab structure, each tab may include a group of selectable game action choices. A player may select the group of selectable game action choices that are to be displayed by selecting an appropriate tab.

In the context of virtual farming game, the game action selection menu 1000 may display selectable game action choices that depend on the state of a plot of land. Some embodiments of the transition the state of a plot of land based on a harvest mechanic. The harvest mechanic may move a plot of land from: (1) an empty plot game state, (2) to a waterable game state, (3) to a waiting state, (4) to a harvestable game state, and (5) back to an empty plot game state. The available game actions for a waiting state may include planting a type of crop (the type of crop may depend on the inventory of the player). Once a crop is planted, the game engine 308 may transition the state of the plot to a waterable game state. The available game actions for a waterable game state may include watering the plot. Once the plot is watered, the game engine 308 may transition the state of the plot to a waiting state. The waiting state may be associated with a timer, and when the timer expires, the game engine may transition the plot to the harvestable game state. The available game actions for the harvestable game state may include harvesting the crop grown in the plot. Once a crop is harvested, the game engine 308 may transition the state of the plot back to the empty plot game state.

### Example Data Flow

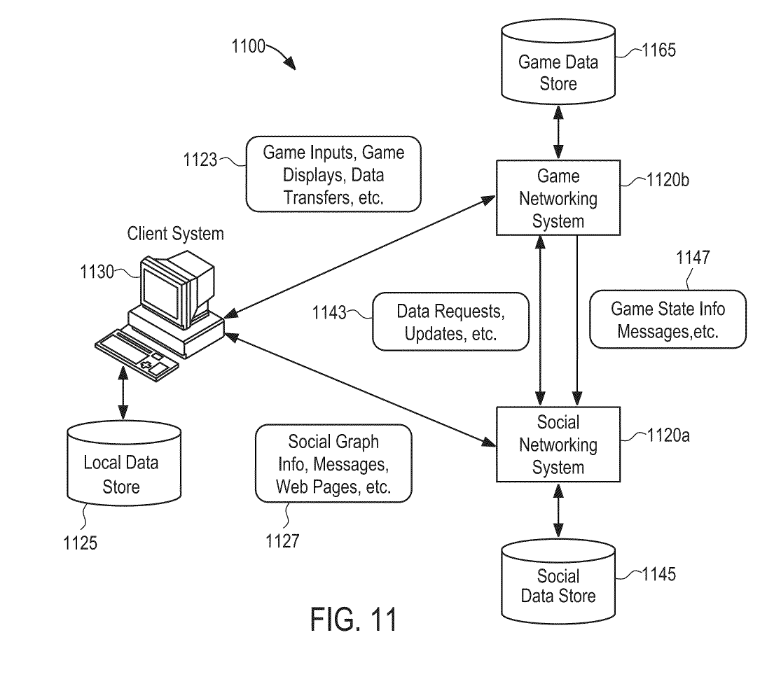

FIG. 11 illustrates an example data flow between the components of system 1100. In particular embodiments, system 1100 can include client system 1130, social networking system 1120a, and game networking system 1120b. The components of system 1100 can be connected to each other in any suitable configuration, using any suitable type of connection. The components may be connected directly or over any suitable network. Client system 1130, social networking system 1120a, and game networking system 1120b can each have one or more corresponding data stores such as local data store 1125, social data store 1145, and game data store 1165, respectively. Social networking system 1120a and game networking system 1120b can also have one or more servers that can communicate with client system 1130 over an appropriate network. Social networking system 1120a and game networking system 1120b can have, for example, one or more internet servers for communicating with client system 1130 via the Internet. Similarly, social networking system 1120a and game networking system 1120b can have one or more mobile servers for communicating with client system 1130 via a mobile network (e.g., GSM, PCS, Wi-Fi, WPAN, and the like). In some embodiments, one server may be able to communicate with client system 1130 over both the Internet and a mobile network. In other embodiments, separate servers can be used.

Client system 1130 can receive and transmit data 1123 to and from game networking system 1120b. This data can include, for example, webpages, messages, game inputs, game displays, HTTP packets, data requests, transaction information, updates, and other suitable data. At some other time, or at the same time, game networking system 1120b can communicate data 1143, 1147 (e.g., game state information, game system account information, page info, messages, data requests, updates, and so forth) with other networking systems, such as social networking system 1120a (e.g., Facebook®, Myspace, and the like). Client system 1130 can also receive and transmit data 1127 to and from social networking system 1120a. This data can include, for example, webpages, messages, social graph information, social network displays, HTTP packets, data requests, transaction information, updates, and other suitable data.

Communication between client system 1130, social networking system 1120a, and game networking system 1120b can occur over any appropriate electronic communication medium or network using any suitable communications protocols. For example, client system 1130, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTP-S, FTP, SNMP, TELNET, and a number of other protocols. In addition, a server in one interaction context may be a client in another interaction context. In particular embodiments, the information transmitted between hosts may be formatted as HyperText Markup Language (HTML) documents. Other structured document languages or formats can be used, such as XML, and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, an instance of an online game can be stored as a set of game state parameters that characterize the state of various in-game objects, such as, for example, player character state parameters, non-player character parameters, and virtual item parameters. In particular embodiments, game state is maintained in a database as a serialized, unstructured string of text data as a so-called Binary Large Object (BLOB). When a player accesses an online game on game networking system 1120b, the BLOB containing the game state for the instance corresponding to the player can be transmitted to client system 1130 for use by a client-side executed object to process. In particular embodiments, the client-side executable may be a FLASH-based game, which can de-serialize the game state data in the BLOB. As a player plays the game, the game logic implemented at client system 1130 maintains and modifies the various game state parameters locally. The client-side game logic may also batch game events, such as mouse clicks, and transmit these events to game networking system 1120b. Game networking system 1120b may itself operate by retrieving a copy of the BLOB from a database or an intermediate memory cache (memcache) layer. Game networking system 1120b can also de-serialize the BLOB to resolve the game state parameters and execute its own game logic based on the events in the batch file of events transmitted by the client to synchronize the game state on the server side. Game networking system 1120b may then re-serialize the game state, now modified, into a BLOB and pass this to a memory cache layer for lazy updates to a persistent database.

With a client-server environment in which the online games may run, one server system, such as game networking system 1120b, may support multiple client systems 1130. At any given time, there may be multiple players at multiple client systems 1130, all playing the same online game. In practice, the number of players playing the same game at the same time may be very large. As the game progresses with each player, multiple players may provide different inputs to the online game at their respective client systems 1130, and multiple client systems 1130 may transmit multiple player inputs and/or game events to game networking system 1120b for further processing. In addition, multiple client systems 1130 may transmit other types of application data to game networking system 1120b.

In particular embodiments, a computer-implemented game may be a text-based or turn-based game implemented as a series of web pages that are generated after a player selects one or more actions to perform. The web pages may be displayed in a browser client executed on client system 1130. As an example and not by way of limitation, a client application downloaded to client system 1130 may operate to serve a set of webpages to a player. As another example and not by way of limitation, a computer-implemented game may be an animated or rendered game executable as a stand-alone application or within the context of a webpage or other structured document. In particular embodiments, the computer-implemented game may be implemented using Adobe Flash-based technologies. As an example and not by way of limitation, a game may be fully or partially implemented as a SWF (Small Web Format) object that is embedded in a web page and executable by a Flash media player plug-in. In particular embodiments, one or more described webpages may be associated with or accessed by social networking system 1120a. This disclosure contemplates using any suitable application for the retrieval and rendering of structured documents hosted by any suitable network-addressable resource or website.

Application event data of a game is any data relevant to the game (e.g., player inputs). In particular embodiments, each application datum may have a name and a value, and the value of the application datum may change (i.e., be updated) at any time. When an update to an application datum occurs at client system 1130, either caused by an action of a game player or by the game logic itself, client system 1130 may need to inform game networking system 1120b of the update. For example, if the game is a farming game with a harvest mechanic (such as Zynga® FarmVille), an event can correspond to a player clicking on a parcel of land to harvest a crop. In such an instance, the application event data may identify an event or action (e.g., harvest) and an object in the game to which the event or action applies. For illustration purposes and not by way of limitation, system 1100 is discussed in reference to updating a multi-player online game hosted on a network-addressable system (such as, for example, social networking system 1120a or game networking system 1120b), where an instance of the online game is executed remotely on a client system 1130, which then transmits application event data to the hosting system such that the remote game server synchronizes game state associated with the instance executed by the client system 1130.

In particular embodiments, one or more objects of a game may be represented as an Adobe® Flash (or other authoring environment, such as HTML5) object. Flash may manipulate vector and raster graphics, and supports bidirectional streaming of audio and video. “Flash” may mean the authoring environment, the player, or the application files. In particular embodiments, client system 1130 may include a Flash client. The Flash client may be configured to receive and run Flash application or game object code from any suitable networking system (such as, for example, social networking system 1120a or game networking system 1120b). In particular embodiments, the Flash client may be run in a browser client executed on client system 1130. A player can interact with Flash objects using client system 1130 and the Flash client. The Flash objects can represent a variety of in-game objects. Thus, the player may perform various in-game actions on various in-game objects by make various changes and updates to the associated Flash objects. In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In particular embodiments, when the player makes a change to a Flash object representing an in-game object, the client-executed game logic may update one or more game state parameters associated with the in-game object. To ensure synchronization between the Flash object shown to the player at client system 1130, the Flash client may send the events that caused the game state changes to the in-game object to game networking system 1120b. However, to expedite the processing and hence the speed of the overall gaming experience, the Flash client may collect a batch of some number of events or updates into a batch file. The number of events or updates may be determined by the Flash client dynamically or determined by game networking system 1120b based on server loads or other factors. For example, client system 1130 may send a batch file to game networking system 1120b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In particular embodiments, each application datum may have a name and a value. The value of an application datum may change at any time in response to the game play of a player or in response to the game engine (e.g., based on the game logic). In particular embodiments, an application data update occurs when the value of a specific application datum is changed. In particular embodiments, each application event datum may include an action or event name and a value (such as an object identifier). Thus, each application datum may be represented as a name-value pair in the batch file. The batch file may include a collection of name-value pairs representing the application data that have been updated at client system 1130. In particular embodiments, the batch file may be a text file and the name-value pairs may be in string format.

In particular embodiments, when a player plays an online game on client system 1130, game networking system 1120b may serialize all the game-related data, including, for example and without limitation, game states, game events, user inputs, for this particular user and this particular game into a BLOB and stores the BLOB in a database. The BLOB may be associated with an identifier that indicates that the BLOB contains the serialized game-related data for a particular player and a particular online game. In particular embodiments, while a player is not playing the online game, the corresponding BLOB may be stored in the database. This enables a player to stop playing the game at any time without losing the current state of the game the player is in. When a player resumes playing the game next time, game networking system 1120b may retrieve the corresponding BLOB from the database to determine the most-recent values of the game-related data. In particular embodiments, while a player is playing the online game, game networking system 1120b may also load the corresponding BLOB into a memory cache so that the game system may have faster access to the BLOB and the game-related data contained therein.

### Example Network Systems

In particular embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

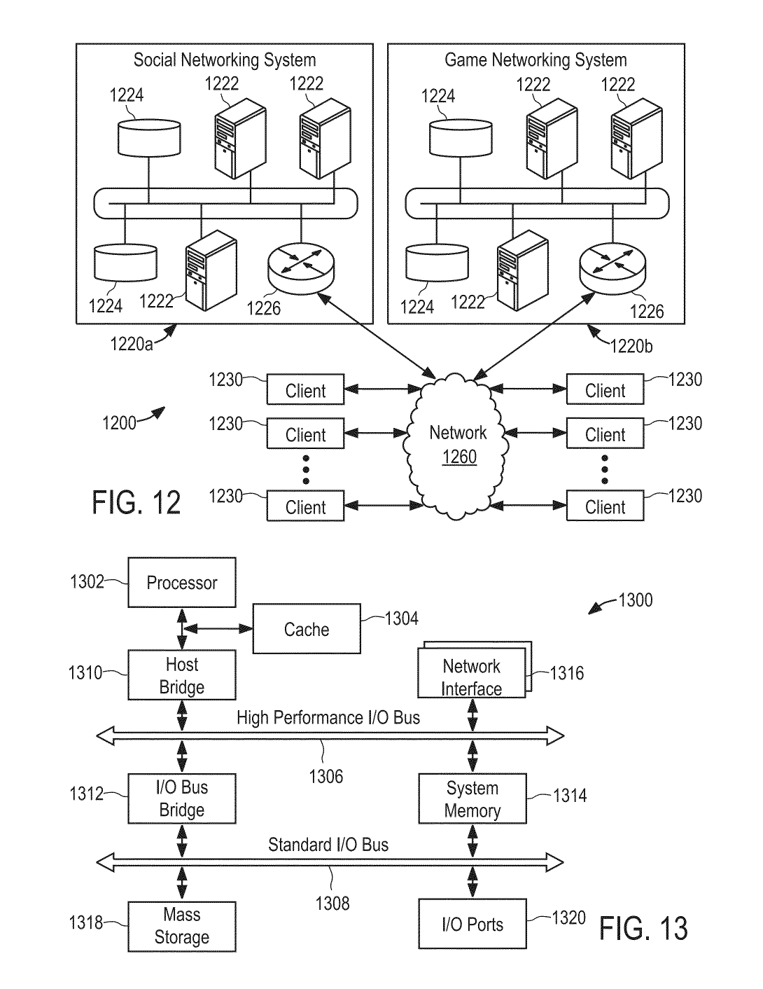

Particular embodiments may operate in a wide area network environment, such as the Internet, including multiple network addressable systems. FIG. 12 illustrates an example network environment, in which various example embodiments may operate. Network cloud 1260 generally represents one or more interconnected networks, over which the systems and hosts described herein can communicate. Network cloud 1260 may include packet-based wide area networks (such as the Internet), private networks, wireless networks, satellite networks, cellular networks, paging networks, and the like. As FIG. 12 illustrates, particular embodiments may operate in a network environment comprising one or more networking systems, such as social networking system 1220a, game networking system 1220b, and one or more client systems 1230. The components of social networking system 1220a and game networking system 1220b operate analogously; as such, hereinafter they may be referred to simply at networking system 1220. Client systems 1230 are operably connected to the network environment via a network service provider, a wireless carrier, or any other suitable means.

Networking system 1220 is a network addressable system that, in various example embodiments, comprises one or more physical servers 1222 and data stores 1224. The one or more physical servers 1222 are operably connected to computer network 1260 via, by way of example, a set of routers and/or networking switches 1226. In an example embodiment, the functionality hosted by the one or more physical servers 1222 may include web or HTTP servers, FTP servers, as well as, without limitation, webpages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), Flash, ActionScript, and the like.

Physical servers 1222 may host functionality directed to the operations of networking system 1220. Hereinafter servers 1222 may be referred to as server 1222, although server 1222 may include numerous servers hosting, for example, networking system 1220, as well as other content distribution servers, data stores, and databases. Data store 1224 may store content and data relating to, and enabling, operation of networking system 1220 as digital data objects. A data object, in particular embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, and the like. Logically, data store 1224 corresponds to one or more of a variety of separate and integrated databases, such as relational databases and object-oriented databases, that maintain information as an integrated collection of logically related records or files stored on one or more physical systems. Structurally, data store 1224 may generally include one or more of a large class of data storage and management systems. In particular embodiments, data store 1224 may be implemented by any suitable physical system(s) including components, such as one or more database servers, mass storage media, media library systems, storage area networks, data storage clouds, and the like. In one example embodiment, data store 1224 includes one or more servers, databases (e.g., MySQL), and/or data warehouses. Data store 1224 may include data associated with different networking system 1220 users and/or client systems 1230.

Client system 1230 is generally a computer or computing device including functionality for communicating (e.g., remotely) over a computer network. Client system 1230 may be a desktop computer, laptop computer, personal digital assistant (PDA), in- or out-of-car navigation system, smart phone or other cellular or mobile phone, or mobile gaming device, among other suitable computing devices. Client system 1230 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 1230 to enter addresses of specific network resources to be retrieved, such as resources hosted by networking system 1220. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is the Hypertext Markup Language (HTML). Other common web browser-supported languages and technologies include the Extensible Markup Language (XML), the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 1230 desires to view a particular webpage (hereinafter also referred to as a target structured document) hosted by networking system 1220, the user's web browser, or other document rendering engine or suitable client application, formulates and transmits a request to networking system 1220. The request generally includes a URL or other document identifier as well as metadata or other information. By way of example, the request may include information identifying the user, such as a user ID, as well as information identifying or characterizing the web browser or operating system running on the user's client computing device 1230. The request may also include location information identifying a geographic location of the user's client system or a logical network location of the user's client system. The request may also include a timestamp identifying when the request was transmitted.

Although the example network environment described above and illustrated in FIG. 12 is described with respect to social networking system 1220a and game networking system 1220b, this disclosure encompasses any suitable network environment using any suitable systems. As an example and not by way of limitation, the network environment may include online media systems, online reviewing systems, online search engines, online advertising systems, or any combination of two or more such systems.

### Example Computer System

FIG. 13 illustrates an example computing system architecture, which may be used to implement a server 1222 or a client system 1230. In one embodiment, a hardware system 1300 comprises a processor 1302, a cache memory 1304, and one or more executable modules and drivers, stored on a tangible computer readable medium, directed to the functions described herein. Additionally, hardware system 1300 may include a high performance input/output (I/O) bus 1306 and a standard I/O bus 1308. A host bridge 1310 may couple processor 1302 to high performance I/O bus 1306, whereas I/O bus bridge 1312 couples the two buses 1306 and 1308 to each other. A system memory 1314 and one or more network/communication interfaces 1316 may couple to bus 1306. Hardware system 1300 may further include video memory (not shown) and a display device coupled to the video memory. Mass storage 1318 and I/O ports 1320 may couple to bus 1308. Hardware system 1300 may optionally include a keyboard, a pointing device, and a display device (not shown) coupled to bus 1308. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 1300 are described in greater detail below. In particular, network interface 1316 provides communication between hardware system 1300 and any of a wide range of networks, such as an Ethernet (e.g., IEEE 802.3) network, a backplane, and so forth. Mass storage 1318 provides permanent storage for the data and programming instructions to perform the above-described functions implemented in servers 1222, whereas system memory 1314 (e.g., DRAM) provides temporary storage for the data and programming instructions when executed by processor 1302. I/O ports 1320 are one or more serial and/or parallel communication ports that provide communication between additional peripheral devices, which may be coupled to hardware system 1300.

Hardware system 1300 may include a variety of system architectures and various components of hardware system 1300 may be rearranged. For example, cache 1304 may be on-chip with processor 1302. Alternatively, cache 1304 and processor 1302 may be packed together as a “processor module,” with processor 1302 being referred to as the “processor core.” Furthermore, certain embodiments of the present disclosure may not require nor include all of the above components. For example, the peripheral devices shown coupled to standard I/O bus 1308 may couple to high performance I/O bus 1306. In addition, in some embodiments, only a single bus may exist, with the components of hardware system 1300 being coupled to the single bus. Furthermore, hardware system 1300 may include additional components, such as additional processors, storage devices, or memories.

An operating system manages and controls the operation of hardware system 1300, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other embodiments are possible. For example, the functions described herein may be implemented in firmware or on an application-specific integrated circuit.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and ^{“}website” may be used interchangeably and additionally may refer to a custom or generalized API on a device, such as a mobile device (e.g., cellular phone, smart phone, personal GPS, personal digital assistance, personal gaming device, and the like), that makes API calls directly to a server. Still further, while the embodiments described above operate with business-related virtual objects (such as stores and restaurants), the invention can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A computer-implemented method, comprising:
generating, by one or more processors, a virtual gaming environment on a client system, the virtual gaming environment including a first game object and a second game object;
responsive to detecting a user selection of the first game object, generating, by the one or more processors, a game object grouping that includes the first game object and the second game object based on matching criteria that compares a property of the first game object with a property of the second game object; and
updating, by the one or more processors, the virtual environment to provide a visual indication of the game object group.

2. The computer-implemented method of claim 1, wherein the property of the first game object specifies a location of the first game object within the virtual game environment, the property of the second game object specifies a location of the second game object within the virtual environment, and the matching criteria determines that the location of the first game object is adjacent to the location of the second game object.

3. The computer-implemented method of claim 1, wherein the property of the first game object specifies an available game action able to be executed on the first game object, the property of the second game object specifies an available game action able to be executed on the second game object, and the matching criteria determines that the available game action able to be executed on the first game object matches the available game action able to be executed on the second game object.

4. The computer-implemented method of claim 1, further comprising responsive to detecting a user initiated game action, performing the user initiated game action on both the first game object and the second game object based on the first game object and the second game object being in the game object grouping.

5. The computer-implemented method of claim 4, wherein the user initiated game action is of a game action type selected from a plurality of selectable game choices displayed in a game action selection menu, the presence of the plurality of other selectable game choices being dependent of the game object grouping.

6. The computer-implemented method of claim 5, wherein the game action selection menu is organized as a rotating wheel menu.

7. The computer-implemented method of claim 1, wherein the first game object and the second game object both represent plots of land within the virtual environment that are in the same harvest state.

8. The computer-implemented method of claim 7, wherein the same harvest state represents an empty plot game state.

9. The computer-implemented method of claim 7, wherein the same harvest state represents a harvestable game state.

10. The computer-implemented method of claim 7, wherein the same harvest state represents a waterable game state.

11. A computer-implemented system, comprising:
a user interface module implemented by one or more processors and configured to generate a virtual gaming environment on a client system, the virtual gaming environment including a first game object and a second game object; and
a game object grouping module implemented by the one or more processors and configured to:
responsive to detecting a user selection of the first game object, generate, by the one or more processors, a game object grouping that includes the first game object and the second game object based on matching criteria that compares a property of the first game object with a property of the second game object, and
update the virtual environment to provide a visual indication of the game object group.

12. The computer-implemented system of claim 11, wherein the property of the first game object specifies a location of the first game object within the virtual game environment, the property of the second game object specifies a location of the second game object within the virtual environment, and the matching criteria determines that the location of the first game object is adjacent to the location of the second game object.

13. The computer-implemented system of claim 11, wherein the property of the first game object specifies an available game action able to be executed on the first game object, the property of the second game object specifies an available game action able to be executed on the second game object, and the matching criteria determines that the available game action able to be executed on the first game object matches the available game action able to be executed on the second game object.

14. The computer-implemented system of claim 11, further comprising a group game action module implemented by the one or more processors and configured to, responsive to detecting a user initiated game action, perform the user initiated game action on both the first game object and the second game object based on the first game object and the second game object being in the game object grouping.

15. The computer-implemented system of claim 14, wherein the user initiated game action is of a game action type selected from a plurality of selectable game choices displayed in a game action selection menu, the presence of the plurality of other selectable game choices being dependent of the game object grouping.

16. The computer-implemented system of claim 15, wherein the game action selection menu is organized as a rotating wheel menu.

17. The computer-implemented system of claim 11, wherein the first game object and the second game object both represent plots of land within the virtual environment that are in the same harvest state.

18. The computer-implemented system of claim 17, wherein the same harvest state represents an empty plot game state.

19. The computer-implemented system of claim 17, wherein the same harvest state represents a harvestable game state.

20. A non-transitory computer-readable medium storing executable instructions thereon, which, when executed by a processor, cause the processor to perform operations comprising:
generating a virtual gaming environment on a client system, the virtual gaming environment including a first game object and a second game object;
responsive to detecting a user selection of the first game object, generating a game object grouping that includes the first game object and the second game object based on matching criteria that compares a property of the first game object with a property of the second game object; and
updating the virtual environment to provide a visual indication of the game object group.
